(19) United States
(12) Patent Application Publication
(10) Pub. No.: US 2004/0021365 A1
(43) Pub. Date: Feb. 5, 2004

(54) Two-piece vehicle wheel

(76) Inventor: Alan Georgeff, Newbury Park, CA (US)

Correspondence Address: Dennis H. Lambert, 7000 View Park Drive, Burke, VA, 22015, US

(21) Appl. No.: 10/437,360

(22) Filed: May 13, 2003

Related U.S. Application Data
(60) Provisional application No. 60/379,850, filed on May 13, 2002.

(51) Int. Cl. B60B 25/00

(52) U.S. Cl. 301/11.2

(57) ABSTRACT

A lightweight but strong two-piece wheel has an outer annular rim with a separate center section secured therein by separate fasteners which are hidden from view when the wheel is in use. The preferred fasteners are threaded bolts extended through openings in the rim and into pre-tapped holes in the center section, but bolt and nut assemblies or rivets may be used in alternate embodiments. The annular rim and center section preferably are made of lightweight materials, including aluminum and plastic. The construction enables the center section to be fastened to the rim in different axial positions within the rim, and permits inexpensive substitution of different center section designs in a common rim design. The process of making the wheel includes heat shrinking the rim onto the center section in a desired axially adjusted position and then applying the fasteners to secure the rim and center section together.

This application claims the benefit of U.S. Provisional patent application serial No. 60/379,850, filed May 13, 2002.

### BACKGROUND OF THE INVENTION

1. Field of the Invention

This invention relates generally to vehicle wheels. More specifically, the invention relates to a two-piece vehicle wheel that is superior in construction and performance to conventional wheels.

2. Prior Art

Vehicle wheels, especially for automotive and small truck use, have in the past most commonly been made of steel, although the trend in recent years has been to make wheels out of lightweight metals or metal alloys. Some wheels are made in two parts, with a center part welded to a surrounding rim. Steel wheels, for instance, are generally made in this manner. Welding of the center part to the rim part is generally satisfactory in wheels made of steel, but when metals such as aluminum are used the weld may not be strong enough. For instance, the metal in the rim may be only about 0.275 inch thick, and the weld can penetrate one half this thickness, leading to weakness at the welded joint. Welding can also lead to distortion of the parts, or the weld may not be uniform and/or may have other flaws. These factors adversely affect the integrity of the wheel and can lead to fatigue and/or stress failure of the wheel. Additionally, the heat generated by welding impairs the ability to chrome plate or paint the wheels after the parts are assembled, and plating prior to assembly is not entirely satisfactory because of the difficulty of plating in areas where parts join at a sharp angle.

There are also wheel designs that are made in three pieces bolted together, but these designs are labor intensive and costly to make. Moreover, in prior art bolted wheels the bolts are visible. Some original equipment wheels are forged aluminum, but these wheels are very expensive. Further, one-piece wheels have limited versatility. For instance, a separate mold is required for each separate application of the wheel that requires a different offset or other modification, e.g., to adapt the wheel to a different vehicle. This lack of versatility leads to reduced choices and/or to increased cost.

Moreover, conventional wheels are relatively heavy, especially in the larger sizes that are popular today. For instance, a commercially available wheel having a size of 18×9.5 inches can weigh 32 pounds, and 20 inch wheels have an average weight of 48 pounds. This is unsprung weight (weight not supported relative to the ground by the vehicle's suspension system), which adversely affects handling, fuel economy and performance.

Accordingly, there is need for a vehicle wheel that is relatively simple and inexpensive to make, which provides versatility in design, and which is lightweight and exhibits superior strength and performance compared with conventional wheels.

### SUMMARY OF THE INVENTION

The wheel of the invention is made in two pieces of lightweight material that are secured together by using separate hidden fasteners to form a wheel that provides versatility in design and is less costly and has superior strength and performance compared with a conventional wheel.

More particularly, a center section and separate rim are manufactured using lightweight materials and then secured together using separate fasteners to form a wheel having desired features. For instance, the center section can be secured in different axially offset positions in the rim to provide different offsets without the need for making a completely new wheel for each offset; or, different center sections can be secured in a rim to provide different designs without the need for manufacturing a completely new wheel for each new design. In other words, a common rim can be used with different center section designs, and a common center section and rim can be secured together in different axially adjusted positions relative to one another to achieve different wheel offsets.

The fastening system of the invention has great tensile and shear strength, and is more durable than prior art systems. Applicant has discovered that the two piece wheel of the invention unexpectedly meets and even exceeds performance standards related to radial and cornering fatigue.

The design of the wheel of the invention also permits the use of new materials in its manufacture. For instance, the center section can be made of a plastic material, leading to even further reduction in weight. Securing the center section and rim together by use of separate fasteners also enables chrome plating or painting of the wheel, and avoids potential warping or distortion that might be caused by welding.

More specifically, the two piece wheel of the invention comprises a rim made of a lightweight material such as a metal alloy, or metal, e.g., aluminum, with a separate center section also made of a lightweight material, such as plastic, or a metal alloy or metal, e.g., aluminum, secured in the rim. The center section is manufactured in any desired style, typically having a hub portion with openings adapted to receive the wheel studs on the hub of the vehicle, and a plurality of generally radially extending spokes preferably terminating at their outer ends in an annular ring. Depending upon the offset desired, and the particular center section employed, holes are formed through the rim at predetermined locations to register with holes in an outer circumferential portion of the center section.

An important feature of the two-piece wheel of the invention is that the rim is heated to cause it to expand, and the center section is located at the appropriately adjusted axial position in the rim. The rim is then cooled to shrink it onto the center section, and fasteners are extended through the radially oriented openings to secure the rim and center section together. This enables the center section to be located in different axial positions in the rim, and results in the fasteners being hidden from view when the wheel is in use.

In conventional two-piece bolted wheels, the center section is axially abutted against a structure on the rim, in a predetermined fixed axial position with respect to the rim, and bolts are extended in a generally axially oriented direction to secure the two parts together. The bolts are fully visible externally of the wheel when in use.

The fasteners are hidden from view in the assembled wheel, and in a preferred embodiment, comprise threaded bolts extended through the outer annular rim and into pre-tapped threaded holes in the annular ring on the center section. Rivets can also be employed, extended through countersunk holes in the rim and through countersunk openings formed through the annular ring at the locations of the radial spokes.

Thus, for a wheel having seven spokes, there would be seven bolts or rivets. If rivets are employed, they preferably are those made and sold by ______ under the name “Q RIVET”. These rivets come in a variety of sizes, materials and head styles, and provide an internal friction lock with positive retention. They provide good shear strength, moderate hole fill, and weather resistance.

Alternatively, a nut and bolt assembly can be used to retain the center section and hub together.

Suitable plastics for use in making the center section can include the engineering polymers sold by BP Amoco Polymers of Atlanta, Ga., under the names AMODEL (registered trademark of Amoco Oil Company, Chicago, Ill.), RADEL (registered trademark of Amoco Polymers, Inc., Alpharetta, Ga.), and/or UDEL, TORLON, MINDEL, XYDAR and KADEL (registered trademarks of Amoco Performance Products, Atlanta, Ga.), and/or IXEF (registered trademark of Solvay Corporation, Brussels, Belgium). These polymers have excellent mechanical properties such as strength, stiffness, and fatigue and creep resistance, over a wide temperature range.

### BRIEF DESCRIPTION OF THE DRAWINGS

The foregoing advantages of the invention will become apparent from the following detailed description when considered in conjunction with the accompanying drawings, wherein like reference characters designate like parts throughout the several views, and wherein:

FIG. 1 is a front perspective view of a wheel in accordance with the invention.

FIG. 2 is a rear perspective view of the wheel of FIG. 1.

FIG. 3 is a front perspective view of the rim that forms part of the wheel of FIG. 1.

FIG. 4 is a rear perspective view of the rim.

FIG. 5 is a front perspective view of the center section used in the wheel of FIG. 1.

FIG. 6 is a rear perspective view of the center section.

FIG. 7 is an exploded perspective view of the rim and center section.

FIG. 8 is a schematic, exploded, fragmentary perspective view, with portions broken away, looking radially outwardly on the back side of the center section, showing a rivet and portions of the rim and center section and depicting how the rivet is associated with these parts to secure them together.

FIG. 9 is a view similar to FIG. 8, but looking radially inwardly on the front side of the center section.

FIG. 10 is an enlarged sectional view taken through a rivet and the adjoining assembled sections of the rim and center section.

FIG. 11 is a slightly perspective view looking at the outside of the rim used in the wheel of the invention, showing the holes for receiving the rivets or other fasteners for attaching the center section, with the arrows indicating how the holes may be located at different axial positions to obtain different offsets.

FIG. 12 is an enlarged fragmentary perspective view of a portion of the outside of the rim, showing one of the countersunk holes for receiving a fastener.

FIG. 13 is an enlarged fragmentary perspective view of the same area shown in FIG. 12, with a rivet in place.

FIG. 14 is an enlarged, fragmentary perspective view of a portion of the inside of the outer periphery of the center section, at the outer end of one of the spokes, showing the countersunk hole for receiving the fastener.

FIG. 15 is an enlarged, fragmentary perspective of the same area shown in FIG. 14, with the rivet in place.

FIG. 16 is a sectional view of a preferred fastener system for use in the invention, wherein the fastener comprises a threaded flat head alien bolt and a pre-tapped hole in the center section.

FIG. 17 is a fragmentary, exploded perspective view of a portion of the rim and center section, showing use of the flat head allen bolt and pre-tapped hole of FIG. 16.

FIG. 18 is a sectional view of a further alternative fastener, wherein the fastener comprises a threaded flat head allen bolt and nut assembly for securing the center section to the rim.

FIG. 19 depicts a “Q” rivet used in the wheel of the invention.

FIGS. 20 and 21 are tables of various “Q” rivet specifications, with the specifications for one rivet suitable for use in the invention indicated by arrows “A”.

### DETAILED DESCRIPTION OF THE PREFERRED EMBODIMENTS

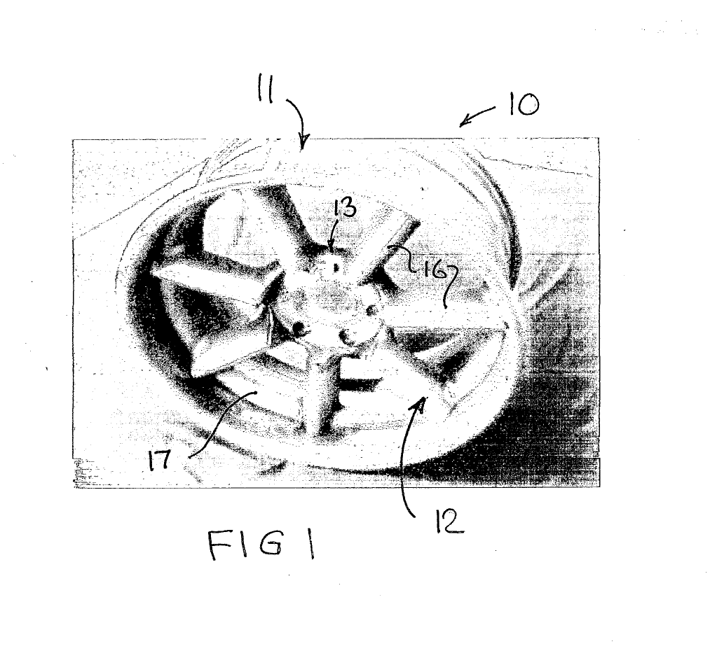

A wheel made in accordance with the invention is indicated generally at 10 in FIGS. 1, 2 and 7. The wheel comprises an annular rim or barrel 11 and a center section 12. In the particular example shown, the center section comprises a rearwardly offset center disc or mounting plate 13 with a central opening 14 and a plurality of smaller openings 15 spaced concentrically around the central opening to receive the wheel studs or hub bolts to mount the wheel to a vehicle. A plurality of radially extending spokes 16 extend between the disc 13 and an outer annular ring 17.

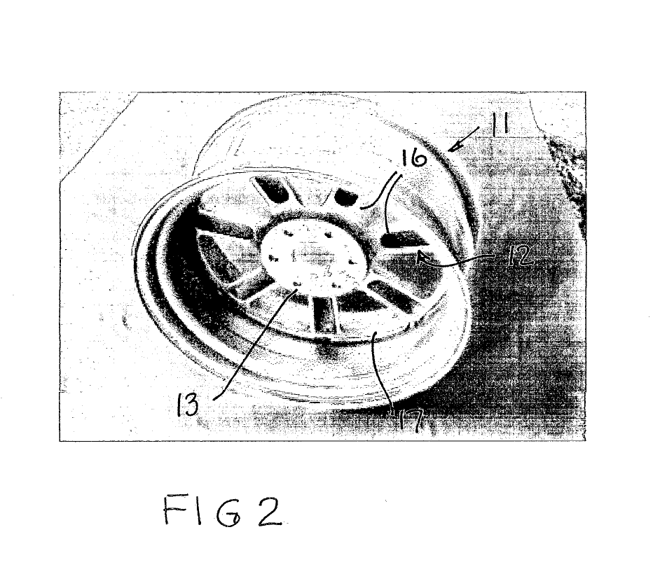

As seen best in FIGS. 2, 6, 8 and 14, the spokes 16 in the particular wheel illustrated are generally triangularly shaped in transverse cross-section, terminating at their radially inner ends in a solid portion 18 at the center disc 13, and terminating at their radially outer ends in a solid wall 19 which is a part of the annular ring 17. Openings 20 are formed through the wall 19 for receiving fasteners, as explained more fully hereinafter.

It should be noted that the invention makes it particularly easy to use other center section designs. In other words, a common rim design could be made, and different center sections secured in it to effect entirely different wheel designs, or just a different offset, etc. This ability significantly reduces the cost of producing different wheel designs.

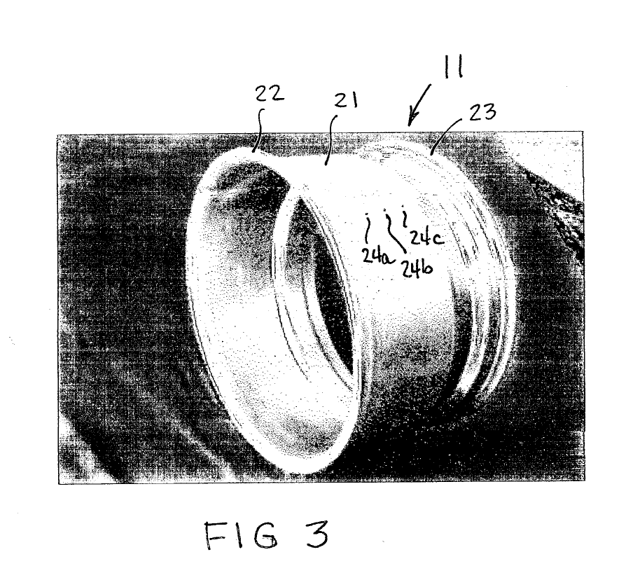

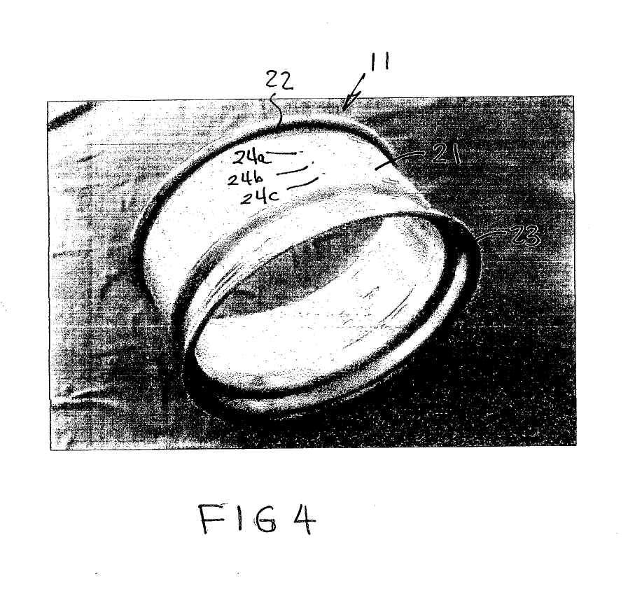

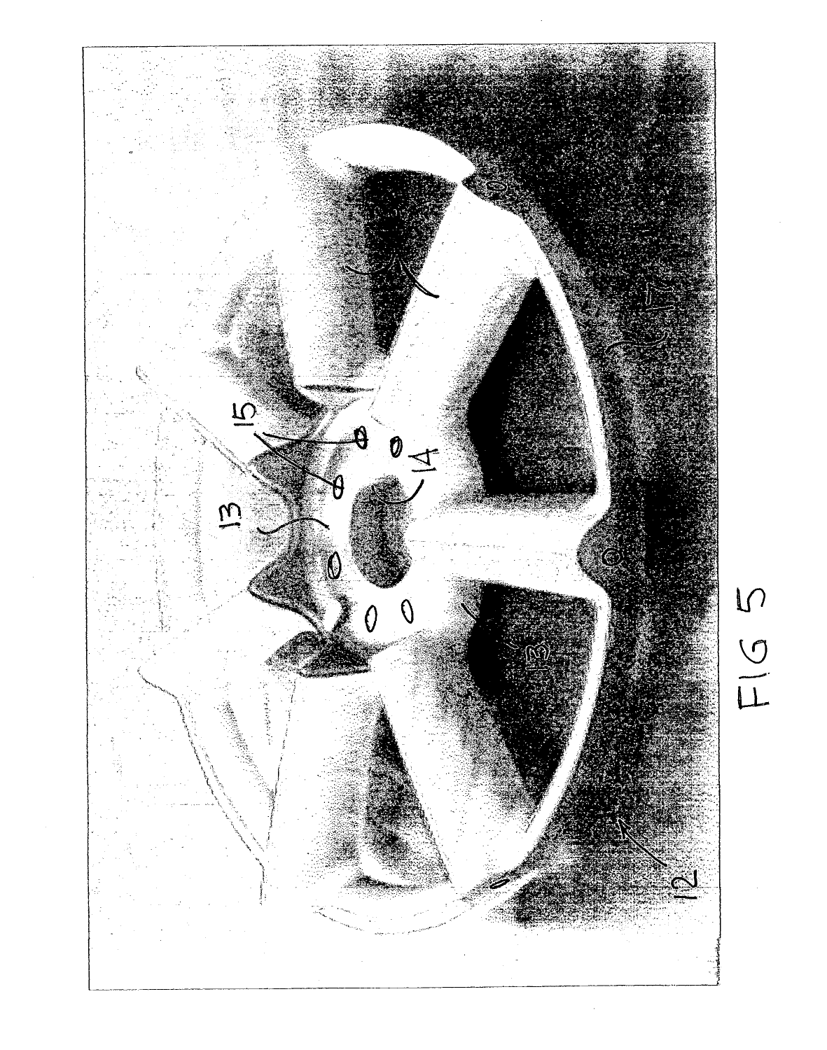

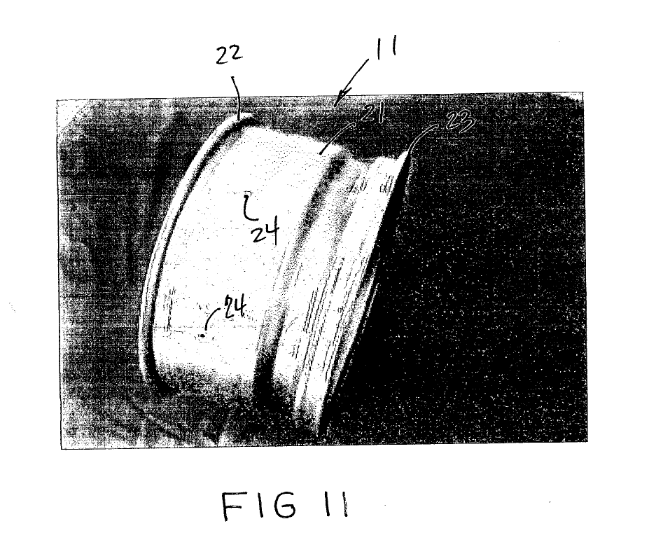

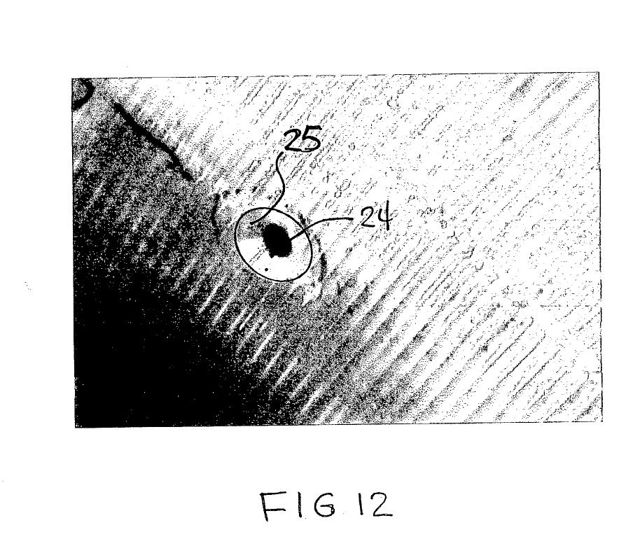

The rim or barrel 11 is essentially conventional in design, i.e., it has an annular center portion 21 with beads 22 and 23 formed on the inner and outer peripheral edges, respectively. Openings 24 are formed through the center portion in predetermined locations to receive fasteners to secure the center section 12 in place in the rim. In the particular example shown, these locations align with the axis of the spokes so that they register with the openings 20 formed through the ring 17 at the periphery of the center section. Depending upon the desired offset for the wheel, the openings 24 are spaced axially a greater or lesser distance from the front or back bead 22 or 23. As seen best in FIGS. 11 and 12, the openings are countersunk at 25 on their radially outer ends at the outer surface of the rim so that when the fastener is installed, whether it is a bolt or a rivet, it is flush with this surface of the rim. FIGS. 3 and 4 show a plurality of openings 24a, 24b, 24c at different axial positions on the rim, but it should be understood that there is only a single axial position for the openings 24 for any given wheel. The showing of multiple openings is only to illustrate how they can be differently axially positioned along the center portion 21 of the rim.

The preferred fastener for securing the center section 12 to the rim 11 comprises a threaded flat head allen bolt 26, which is extended through the countersunk opening 24 in the rim 11 and threaded into pre-tapped opening 20 in the center section 12.

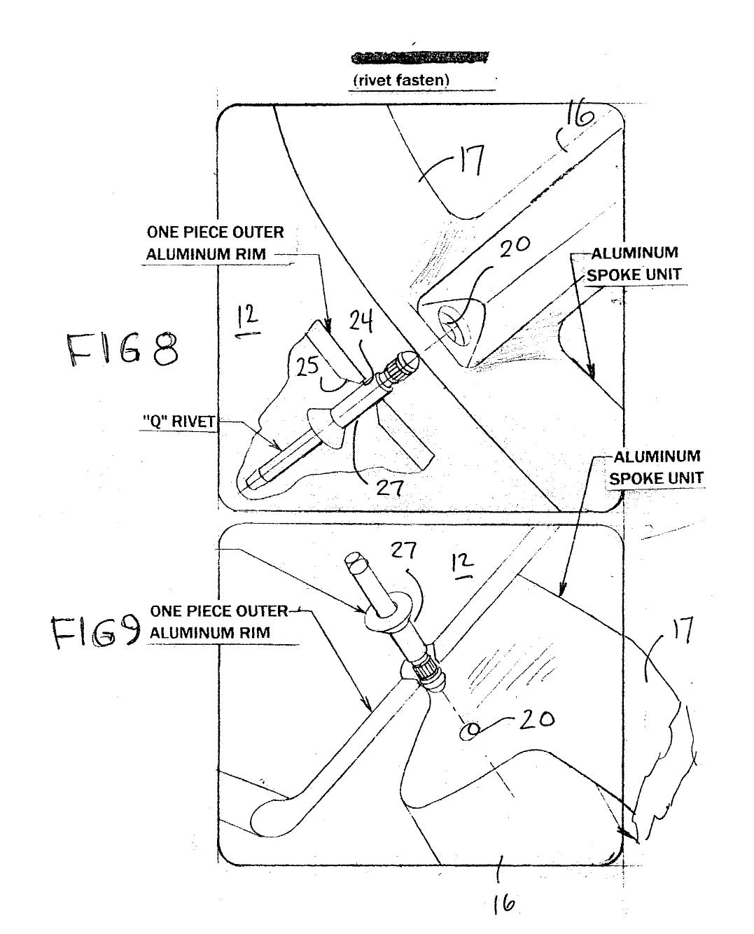

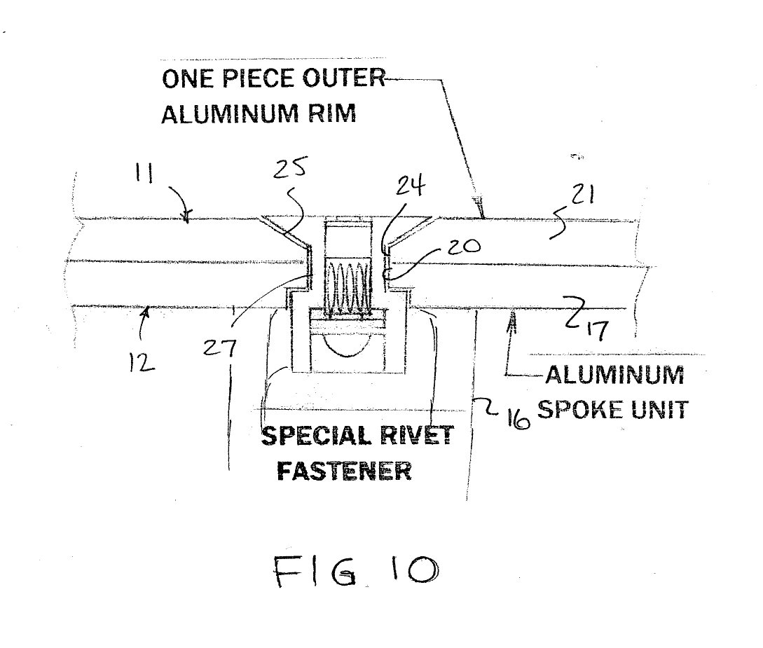

Alternatively a rivet 27, and particularly the “Q”rivet available from ______ may be used to secure the parts together. This rivet has good fastening capabilities and durability, making it suitable for withstanding the stresses and forces encountered in a wheel, and thus for use in the wheel of the invention. As seen in FIGS. 8, 9, 10 and 13, the rivet is applied from outside the rim, and when fully seated substantially fills the countersunk opening 25, providing a flush surface.

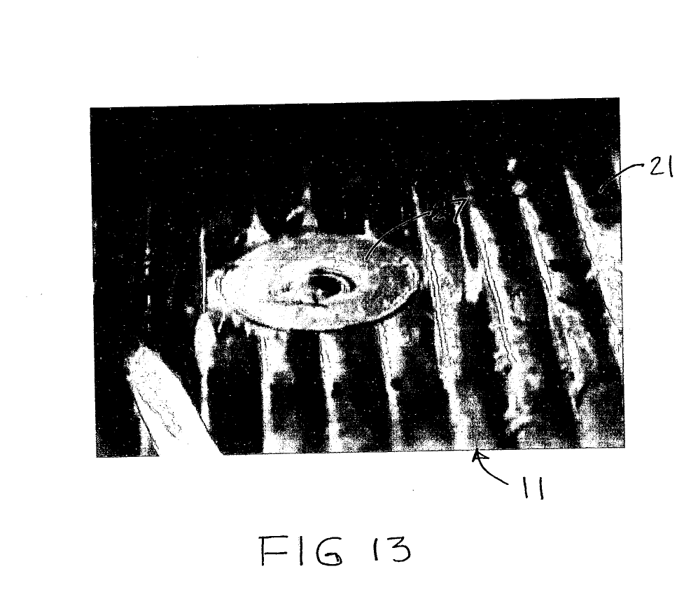

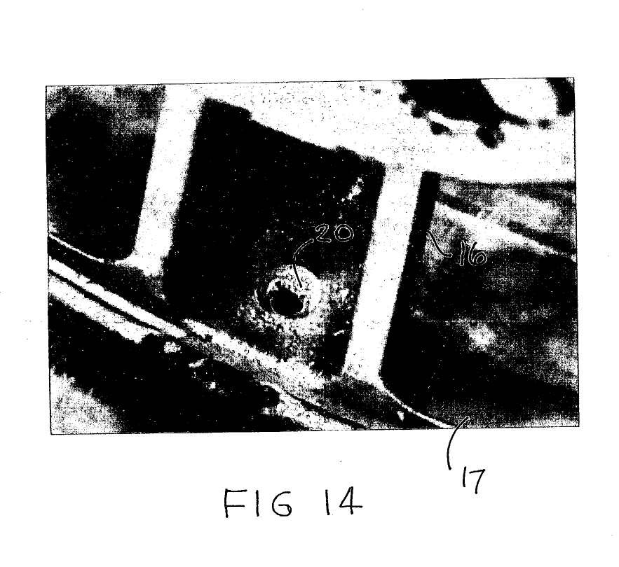

FIG. 14 shows one of the countersunk openings 20 formed through the annular ring 17 of the center section 12, prior to receiving a fastener, and FIG. 15 shows how the opening is filled and made flush when the bolt 26 or rivet is 27 installed.

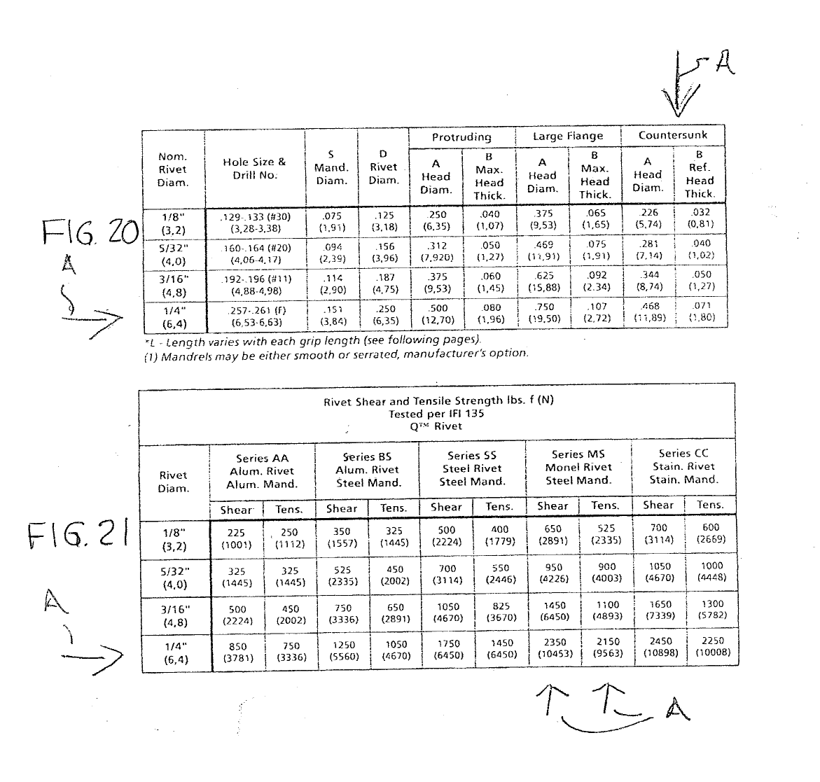

FIG. 19 illustrates a countersunk “Q” rivet 27 preferred for use in the invention. The specifications for a particular example of a “Q” rivet used in the invention are indicated by the arrows “A” in FIGS. 20 and 21.

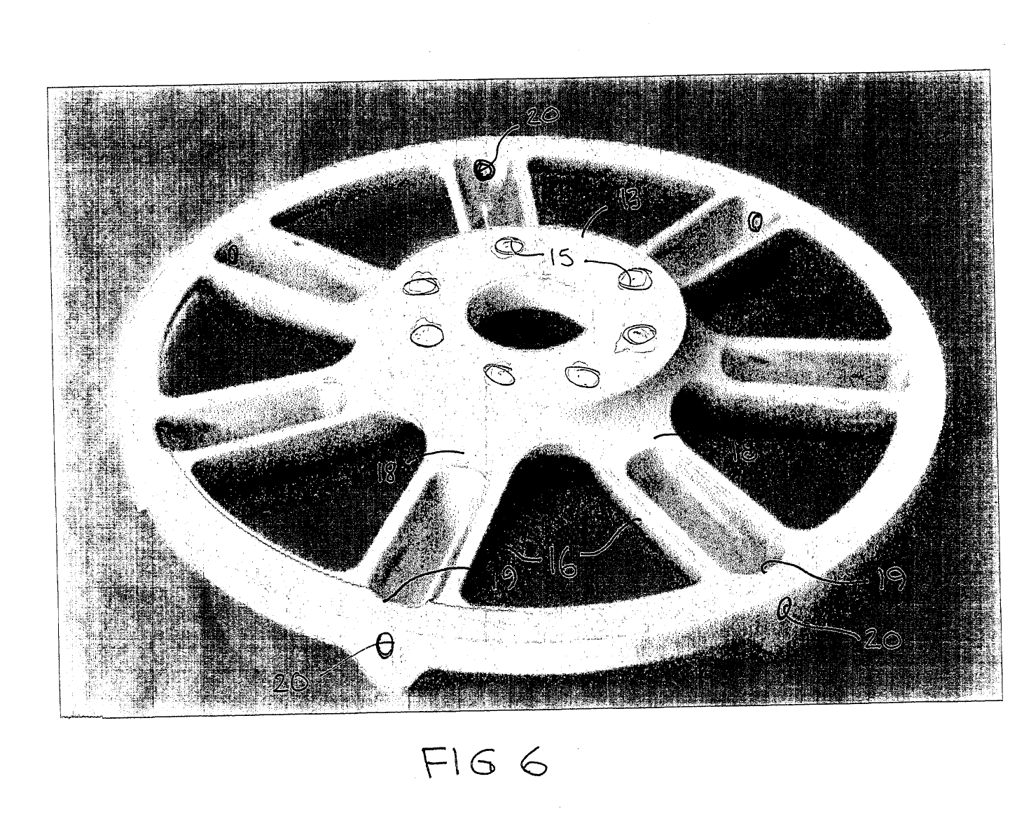

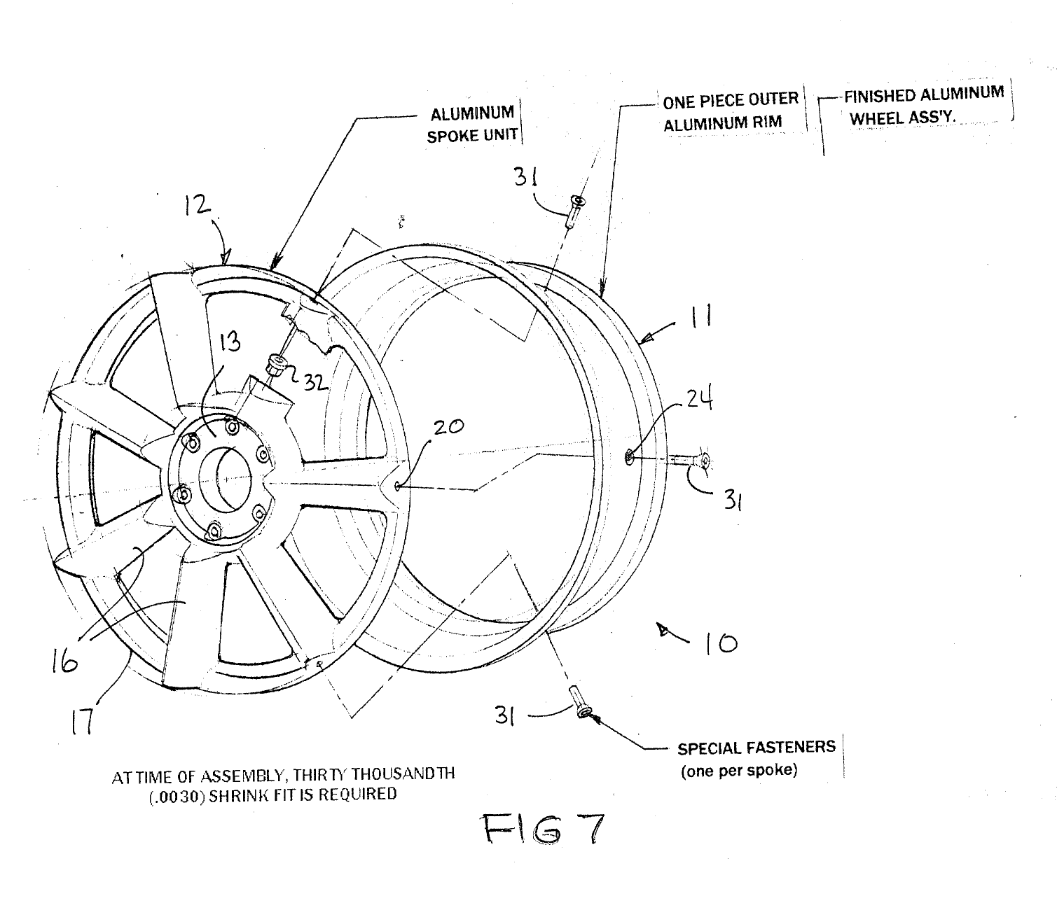

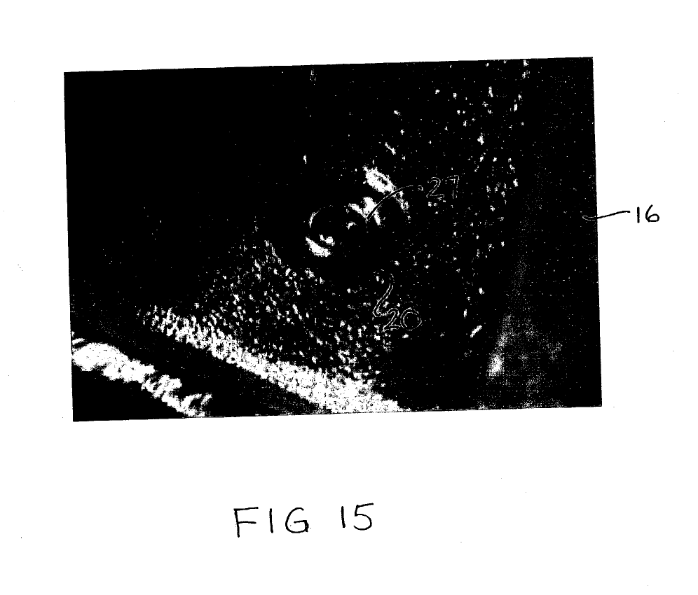

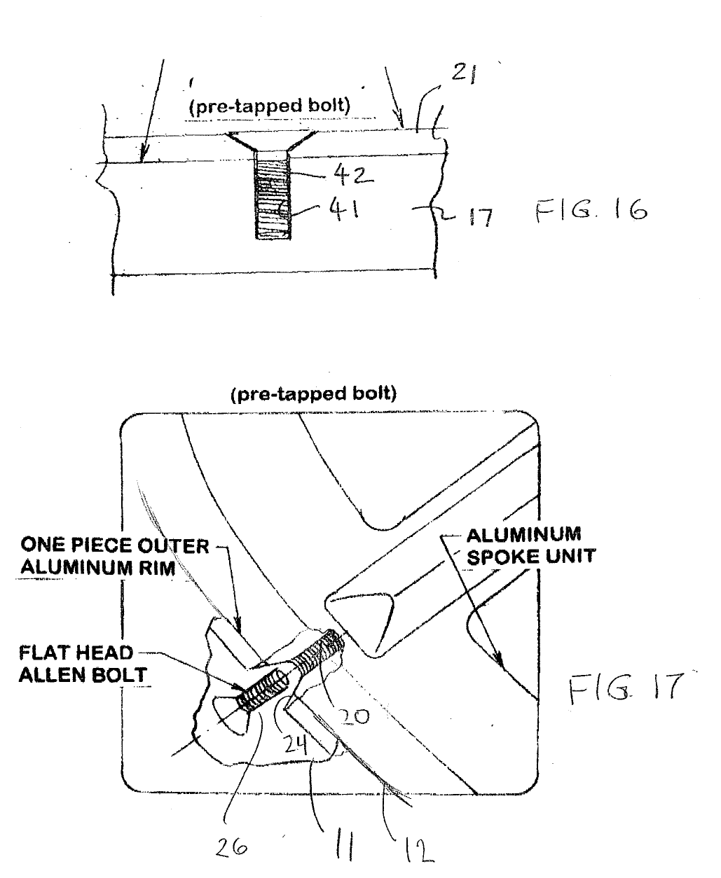

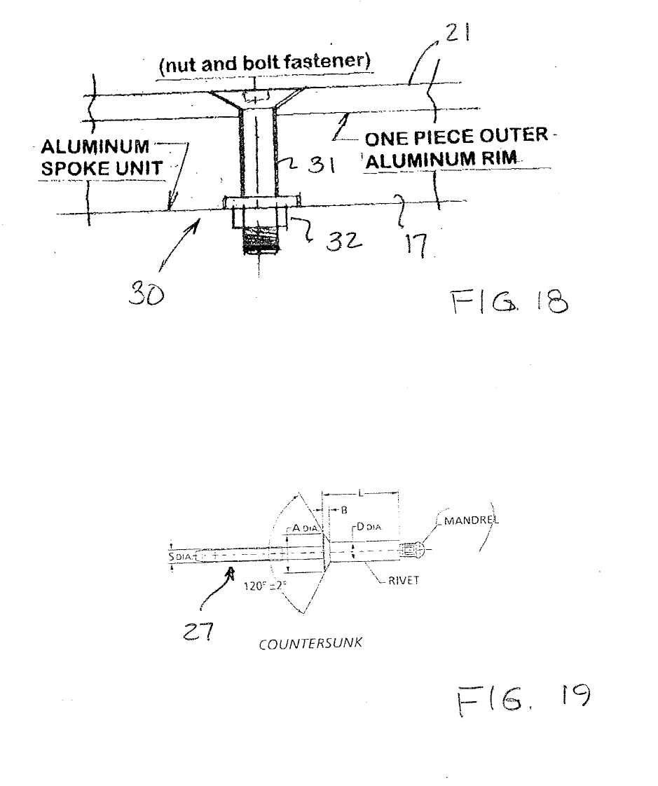

A second alternate fastener that may be used to secure the center section 12 in the rim 11 is indicated at 30 in FIGS. 7 and 16. This fastener comprises a flat-head Allen bolt 31 and locking flange nut 32. As seen in these figures, the bolt is extended inwardly through the openings 24 and 20, and the flange nut is secured on the threaded end of the bolt, located in the radially outer end of a spoke.

A 20×10 inch wheel having an aluminum rim 11 and aluminum center section 12 secured together by ¼ inch diameter “Q” rivets was tested by Goal Automotive Technical Services of El Monte, Calif., for radial and cornering fatigue, with the results shown in Tables 1 and 2, below. These results exceed the specifications for automotive wheels.

TABLE 1
RADIAL FATIGUE TEST

| CUS- | Wheel | | | P.O. NO.: | |
|---|---|---|---|---|---|
| TOMER: | Concepts | | | | |
| WHEEL | 7 Spoke | | | STYLE: | Two |
| NAME: | | | | piece | |
| TEST | SFI 5.1 A | | | MATE- | Alu- |
| SPEC.: | RIAL: | | | inum | |
| SIZE: | 20 × 10 | OFFSET: | +20 mm | CONI- | Yes |
| | | | | | CAL |
| | | | | | LUG: |
| LAB NO.: | 321-05-01 | | | DATE: | Dec. 24, |
| | | | | | 2001 |
| WHEEL | 1999 | | | TEST | 4000 |
| LOAD: | LOAD: | | | | |
| BOLT | 6 × 5.5 | | | PART | A277- |
| CIRCLE: | | | | NO.: | 20106- |
| | | | | | 139729C |
| CYCLES | 500,000 | | | CYCLES | 500,100 |
| REQUIRED: | | | | COM- | |
| | | | | PLETED: | |
| INITIAL | 85 lbs.ft. | | | FINAL | 85/80 |
| LUG NUT | | | | LUG NUT | lbs. ft |
| TORQUE: | | | | TORQUE: | |
| INITIAL | 65 | | | FINAL | 80 |
| TIRE PSI: | TIRE PSI: | | | | |
| TIRE: | Nitto | SIZE: | P 275/55 | LAB | NO |
| | | | R20 | FUR- | |
| | | | | NISHED | |
| | | | | TIRE: | |
| MACHINE | 25 | STATION | 2 | MPH: | 60 |
| NO.: | | NO.: | | | |
| RESULT: | PASS | | | | |

TABLE 2
CORNERING FATIGUE TEST

| | | | |
|---|---|---|---|
| CUSTOMER: | Wheel Concepts | P.O. NO.: | |
| WHEEL NAME: | 7 Spoke | STYLE: | Two piece |
| TEST SPEC.: | SFI 5.3 A | MATERIAL: | Aluminum |
| SIZE: | 20 × 10 | OFFSET: | +20 mm |
| ROLLING | 15.945″ | CONICAL LUG: | YES |
| RADIUS: | | | |
| LAB NO.: | 321-04-01 | DATE: | Dec. 11, 2001 |
| WHEEL LOAD: | 2000 | TEST LOAD: | 3186 |
| BOLT CIRCLE: | 6 × 5.5 | PART NO.: | A277-20106- |
| | | | 139720C |
| CYCLES | 100,000 | CYCLES | 100,100 |
| REQUIRED: | COMPLETED: | | |
| INITIAL LUG | 85 lbs. ft. | FINAL LUG | 85/80 lbs. ft. |
| NUT TORQUE: | NUT TORQUE: | | |
| INITIAL | .205 | FINAL | .205 |
| DEFLECTION: | DEFLECTION: | | |
| MACHINE NO.: | 104 | RPM: | 650 |
| RESULT: | PASS | | |

The 20×10 inch wheel made in accordance with the invention and comprising an aluminum rim and aluminum center section weighs only about 23 pounds, compared with an average 48 pounds for conventional wheels of that size, and has greater strength than a conventional wheel. It is also less expensive to make than most conventional wheels, and provides great flexibility in wheel design, offset, etc. Moreover, the center section can be plated or painted and then assembled to the rim without impairment of the plating or paint.

In an alternate construction of wheel according to the invention, the center section 11 can be made of plastic material. Suitable plastics for use in making the center section can include the engineering polymers sold by BP Amoco Polymers of Atlanta, Ga., under the names AMODEL (registered trademark of Amoco Oil Company, Chicago, Ill.), RADEL (registered trademark of Amoco Polymers, Inc., Alpharetta, Ga.), and/or UDEL, TORLON, MINDEL, XYDAR and KADEL (registered trademarks of Amoco Performance Products, Atlanta, Ga.), and/or IXEF (registered trademark of Solvay Corporation, Brussels, Belgium). These polymers have excellent mechanical properties such as strength, stiffness, and fatigue and creep resistance, over a wide temperature range.

While particular embodiments of the invention have been illustrated and described herein, it is to be understood that variations in the invention could be made without departing from the spirit and scope of the invention, as defined by the appended claims.

What is claimed is:

1. A two-piece vehicle wheel, comprising:
an annular rim;
a generally circularly shaped center section fitted within the rim and secured thereto with separate fasteners to form a wheel having a rim for mounting a tire, and a center section with means to mount the wheel to a vehicle;
said fasteners extending through the rim and into a peripheral portion of the center section to secure the rim and center section together, and said fasteners being substantially hidden from view when the wheel is in use.

2. A wheel as claimed in claim 1, wherein:
the rim and center section are constructed so that the center section may be located in different axial positions within the rim to produce wheels having different offset.

3. A wheel as claimed in claim 2, wherein:
the rim is heated to expand it, then positioned on the center section and cooled to shrink it onto the center section prior to application of the separate fasteners.

4. A wheel as claimed in claim 1, wherein:
the fasteners comprise bolts extended between the rim and the center section.

5. A wheel as claimed in claim 4, wherein:
holes are formed through the rim and the bolts extend in a radial direction through the rim and into the center section.

6. A wheel as claimed in claim 5, wherein:
threaded pre-tapped openings are formed in an outer peripheral portion of the center section, and the bolts are threaded into the pre-tapped openings.

7. A wheel as claimed in claim 6, wherein:
the center section comprises a plurality of radial spokes extending from a center hub to an outer annular ring, and the pre-tapped openings are formed in the annular ring in locations corresponding to locations where the spokes intersect the annular ring.

8. A wheel as claimed in claim 5, wherein:
the center section comprises a plurality of radial spokes extending from a center hub to an outer annular ring, holes are formed through the ring in locations corresponding to locations where the spokes intersect the annular ring, the bolts project at one end through the holes, and nuts are threaded onto the ends of the bolts.

9. A wheel as claimed in claim 1, wherein:
the fasteners comprise rivets extended between the rim and the center section.

10. A wheel as claimed in claim 9, wherein:
holes are formed through the rim and an outer peripheral portion of the center section and the rivets extend in a radial direction through the holes.

11. A wheel as claimed in claim 10, wherein:
the center section comprises a plurality of radial spokes extending from a center hub to an outer annular ring, and the holes are formed in the annular ring in locations corresponding to locations where the spokes intersect the annular ring.

12. A wheel as claimed in claim 1, wherein:
the rim is made of a lightweight metal.

13. A wheel as claimed in claim 12, wherein:
the center section is made of plastic.

13. A wheel as claimed in claim 1, wherein:
the rim and center section are made of a lightweight metal.

14. A wheel as claimed in claim 13, wherein:
the metal is aluminum.

15. A wheel as claimed in claim 7, wherein:
the bolts comprise flat head allen bolts.

16. A wheel as claimed in claim 8, wherein:
the bolts comprise flat head allen bolts.

17. A process of making a two-piece vehicle wheel having an annular rim and a center section secured thereto by separate fasteners extended between the rim and center section, comprising the steps of:
forming an annular rim made of a lightweight metal;
forming a center section made of a lightweight material;
heating the rim to expand it;
placing the heated rim on the center section in a desired axially adjusted position thereon and cooling the rim to shrink it onto the center section; and
extending separate fasteners between the rim and the center section to secure them together.
